(19) United States
(12) Patent Application Publication
(10) Pub. No.: US 2008/0049703 A1
(43) Pub. Date: Feb. 28, 2008

(54) Multicast-only data transmission mode for access points and virtual access points in a wireless network

(75) Inventors: Jarkko Kneckt, Espoo (FI); Jani Poikela, Helsinki (FI)

Correspondence Address: BRAKE HUGHES BELLERMANN LLP, c/o INTELLEVATE, P.O. BOX 52050, MINNEAPOLIS, MN, 55402, US

(73) Assignee: Nokia Corporation

(21) Appl. No.: 11/511,020

(22) Filed: Aug. 28, 2006

(51) Int. Cl. H04B 7/216

(52) U.S. Cl. 370/342

(57) ABSTRACT

Various embodiments are disclosed relating to a multicast-only data transmission mode in a wireless network. According to an example embodiment, an apparatus for wireless communications may include a controller. The apparatus, which may include an AP or a virtual AP may be configured to operate in a multicast-only data transmission mode (e.g., transmitting only multicast and/or broadcast data frames). The AP or virtual AP may operate in a multicast-only data transmission mode to handle multicast transmissions for one or more multicast streams for one or more wireless networks, for example.

### BACKGROUND

The rapid diffusion of Wireless Local Area Network (WLAN) access and the increasing demand for WLAN coverage is driving the installation of a very large number of Access Points (AP). The most common WLAN technology is described in the Institute of Electrical and Electronics Engineers IEEE 802.11 family of industry specifications, such as specifications for IEEE 802.11b, IEEE 802.11g and IEEE 802.11a. A number of different 802.11 task groups are involved in developing specifications relating to improvements to the existing 802.11 technology. A number of other wireless networks or technologies are available, including cellular, Wi-Max or 802.16, and others.

If wireless networks are used in crowded places or areas where there are a significant number of wireless devices attempting to communicate or access the network resources, a number of problems may occur. Congestion usually increases, typically causing a significant number of collisions, and Quality of Service (QoS) usually deteriorates due to, for example, increased delay or latency, dropped packets, etc. The decrease in QoS may be especially problematic for certain types of applications, such as multimedia application (e.g., audio, radio, video or other program transmissions), and other types of applications that may suffer when QoS decreases.

### SUMMARY

Various embodiments are disclosed relating to a multicast-only data transmission mode, such as for access points and virtual access points in a wireless network.

According to an example embodiment, a method is provided. The method may include notifying one or more wireless nodes that an access point (AP) is operating in a multicast-only data transmission mode, and transmitting, from the AP, only multicast data frames (e.g., multicast or broadcast data frames) when operating in a multicast-only data transmission mode. Control frames or management frames (such as a Beacon or Beacon frames, or response messages) may also be transmitted while in multicast-only data transmission mode.

According to an example embodiment, the notifying may include transmitting a Beacon or response message indicating that an access point (AP) is operating in a multi-cast-only data transmission mode. The transmitting the Beacon or response may include, for example, transmitting, from an access point (AP), a Beacon or probe response (for example) that indicates that the AP is operating in a multicast-only data transmission mode, the Beacon or response also identifying a type of multicast data traffic (e.g., audio or radio transmission, IP television program transmission, a sports program transmission, a video program transmission, program guide information to indicate provided services, gaming application data exchange, walkie-talkie like push to talk or video streaming applications, networking protocols . . . ) that is transmitted by the AP for one or more multicast streams, and providing an identifier (e.g., multicast group address, a MAC address or other address of an AP or virtual AP, or other identifier) for each of the one or more multicast streams.

According to another example embodiment, an apparatus for wireless communications may include a controller. The apparatus may be configured to operate in a multicast-only data transmission mode. The apparatus may include a memory and a wireless transceiver. The apparatus may be (or may be provided in), for example, an access point (AP), a base station (BS) or other wireless node.

In an example embodiment, the apparatus being configured to operate in a multicast-only data transmission mode may include the apparatus being configured to notify one or more wireless nodes that the apparatus is operating in a multicast-only data transmission mode, and to transmit control (or management) frames and only multicast data frames while operating in the multicast-only data transmission mode. The multicast data frames may include multicast data frames and/or broadcast data frames.

In an example embodiment, the apparatus may include a device that includes a plurality of virtual access points (APs), the plurality of APs including a first virtual AP operating in a multicast-only data transmission mode for a plurality of networks. In another example embodiment, the apparatus may include at least one virtual AP operating in a unicast-only data transmission mode, and at least one virtual AP operating in a multicast-only data transmission mode (e.g., transmitting multicast and/or broadcast data frames for one or more streams). In yet another example embodiment, the apparatus may include a plurality of first virtual APs, each first AP serving a different one of a plurality of wireless networks, and at least one virtual AP operating in a multicast-only data transmission mode to transmit multicast or broadcast data frames for a multicast or broadcast stream for the plurality of wireless networks.

In another example embodiment, an apparatus for wireless communications is provided. The apparatus may include a plurality of virtual access points (APs), at least one of the virtual APs being configured to operate in a multicast-only data transmission mode. In an example embodiment, the virtual AP configured to operate in a multicast-only data transmission mode may include a virtual AP configured to transmit multicast or broadcast data frames for a multicast stream or broadcast stream over a plurality of wireless networks. The virtual AP operating in multicast-only data transmission mode may be designated to transmit multicast/broadcast data frames for one or more wireless networks.

According to another example embodiment, a method may be provided. The method may include operating a plurality of virtual access points (APs) in one AP device, wherein a first of the virtual APs is provided for a first wireless network, a second virtual AP is provided for a second wireless network, and wherein a third of the virtual APs operates in a multicast-only data transmission mode to provide multicast data transmissions for at least one multicast or broadcast data stream for the first and second wireless networks.

According to another example embodiment, a method may be provided. The method may include operating in unicast-multicast data transmission mode or a normal BSS mode, and switching from the unicast-multicast data transmission mode to a multicast-only data transmission mode. The switching may include, for example, detecting that a wireless traffic condition has been met, and then switching from the unicast-multicast data transmission mode to a multicast-only data transmission mode based on the detecting.

In an example embodiment, the switching may include disassociating from any wireless node that an AP or virtual AP may currently be associated with, discontinuing any further unicast data transmissions, and transmitting only multicast data transmissions in a multicast-only data transmission mode. In another example embodiment, the switching may include, for example, operating, for a period of time, in a parallel operation of a unicast/multicast data transmission mode and a multicast-only data transmission mode, disassociating from any currently associated wireless nodes (e.g., an AP or virtual AP disassociating from any currently associated nodes), and discontinuing operation of the unicast-multicast data transmission mode while continuing operation of the multicast-only data transmission mode.

In another example embodiment, an apparatus is provided. The apparatus may include a controller, a memory coupled to the controller, and a wireless transceiver. The apparatus may be configured to operate in unicast-multicast data transmission mode (e.g., normal BSS mode), detect that a wireless traffic condition has been met (e.g., detecting that wireless traffic congestion has reached a threshold), and switch from the unicast-multicast data transmission mode to a multicast-only data transmission mode.

According to yet another example embodiment an article may be provided. The article may include a storage medium including thereon instructions, when executed by a processor (or controller) may result in notifying one or more wireless nodes that an access point (AP) is operating in a multicast-only data transmission mode, and transmitting, in the multicast-only data transmission mode, control (or management) frames and only multicast or broadcast data frames.

### BRIEF DESCRIPTION OF THE DRAWINGS

The details of one or more implementations are set forth in the accompanying drawings and the description below. Other features will be apparent from the description and drawings, and from the claims.

FIG. 1 is a block diagram illustrating a wireless network according to an example embodiment.

FIG. 2 is a block diagram of an AP device or wireless communications system that may include a plurality of virtual APs operating thereon.

FIG. 3 is a flow chart illustrating operation of a system according to an example embodiment.

FIG. 4 is a flow chart illustrating operation of another system according to an example embodiment.

FIG. 5 is a flow chart illustrating operation of yet another system according to an example embodiment.

FIG. 6 is a block diagram illustrating an apparatus that may be provided for wireless communications according to an example embodiment.

FIG. 7 is a block diagram illustrating a Beacon (or Beacon frame) according to an example embodiment.

FIG. 8 is a diagram illustrating a Reassociation Request frame according to an example embodiment.

FIG. 9 is a diagram illustrating a Reassociation Response frame according to an example embodiment.

### DETAILED DESCRIPTION

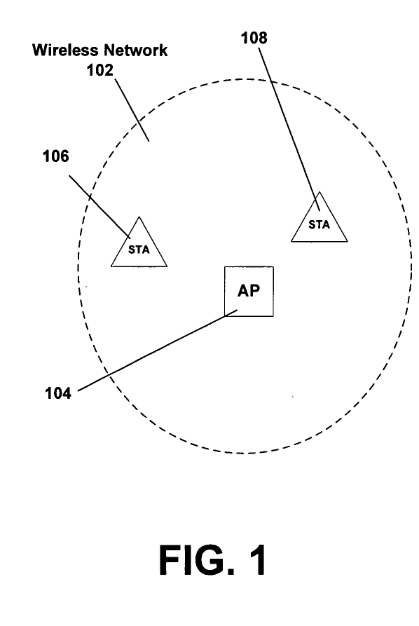

Referring to the Figures in which like numerals indicate like elements, FIG. 1 is a block diagram illustrating a wireless network according to an example embodiment. Wireless network 102 may include a number of wireless nodes or stations, such as an access point (AP) 104 or base station (BS) and one or more mobile stations, such as stations 106 and 108. While only one AP and two mobile stations are shown in wireless network 102, any number of APs and stations may be provided. Each station in network 102 (e.g., stations 106, 108) may be in wireless communication with the AP 104, and may even be in direct communication with each other. Although not shown, AP 104 may be coupled to a fixed network, such as a Local Area Network (LAN), Wide Area Network (WAN), the Internet, etc., and may also be coupled to other wireless networks.

The various embodiments described herein may be applicable to a wide variety of networks and technologies, such as WLAN networks (e.g., IEEE 802.11 type networks), IEEE 802.16 Wi-Max networks, cellular networks, radio networks, or other wireless networks. In another example embodiment, the various examples and embodiments may be applied, for example, to a mesh wireless network, where a plurality of mesh points (e.g., Access Points) may be coupled together via wired or wireless links. The various embodiments described herein may be applied to wireless networks, both in an infrastructure mode where an AP or base station may communicate with a station (e.g., communication occurs through APs), as well as an ad-hoc mode in which wireless stations may communicate directly via a peer-to-peer network, for example.

The term “wireless node” or “node,” or the like, may include, for example, a wireless station, an access point (AP) or base station, a wireless personal digital assistant (PDA), a cell phone, an 802.11 WLAN phone, a wireless mesh point, or any other wireless device. The terms access point (AP) and base station (BS) may be used interchangeably, and may apply to a wide variety of wireless technologies, such as WLAN, Wi-Max, cellular, or other radio networks or wireless networks. These are merely a few examples of the wireless devices that may be used to implement the various embodiments described herein, and this disclosure is not limited thereto.

In an example embodiment, an AP may be providing a basic service set (BSS) for a wireless network, including associating and authenticating with wireless nodes in the network, receiving and forwarding unicast traffic or frames to wireless nodes, and transmitting multicast frames. Multicast frames may include multicast frames (e.g., addressed to multiple nodes) and/or anycast or broadcast frames (e.g., addressed to any or all wireless nodes). Thus, the term multicast may include multicast, anycast and/or broadcast. Therefore, the mode of operation in which an AP (or BS) may transmit both unicast and multicast (including broadcast) frames or traffic may be referred to as a unicast-multicast data transmission mode, since the AP may transmit both unicast and multicast data frames, such as for a normal or BSS mode of operation. Of course other (non-data) frames may be transmitted in unicast-multicast data transmission mode, such as management or control frames, such as a Beacon.

In an example embodiment, an AP may transmit a Beacon to indicate to other wireless nodes one or more features or capabilities of the AP, and other information. The Beacon transmitted by an AP may include a Traffic Indication Map (TIM) every TIM period, and may transmit a Delivery Traffic Indication Map (DTIM) every N TIM periods. Multicast/broadcast data may typically be transmitted by the AP after the AP transmits its DTIM.

A problem may arise, in some situations, if a number of wireless nodes in a wireless network increases and a QoS provided to such wireless nodes may decrease or deteriorate due to congestion, colliding packets, etc. This may be a problem especially in densely populated areas (e.g., office building, downtown area, or city), or areas in which a number of subscribers or mobile stations have gathered together, e.g., to attend an event, etc. (e.g., sporting event or other gathering).

In addition, it is becoming more popular to multicast or broadcast certain types of media over wireless networks, such as radio or audio programs, video or television programs, movies and the like. According to an example embodiment, audio or television or video or multimedia programs may be multicasted using Internet Protocol (IP) or other protocols, e.g., as IP TV transmissions to one or more multicast group addresses. It may be useful or desirable, in some cases, to provide a specific QoS when multicasting (including multicasting and/or broadcasting) traffic streams, e.g., to avoid too many dropped frames or packets, to decrease the amount of delay or latency in the network, etc.

Unfortunately, when wireless networks become congested, many APs (or base stations) may spend a significant amount of the network resources on handling unicast data transmissions, including receiving and transmitting or forwarding unicast data frames to and from mobile stations or wireless nodes. This may result in a decrease of QoS for multicast data transmissions. Also, to the extent that two or more wireless networks may have overlapping wireless coverage, the multicast data frames for a program or transmission may typically be transmitted for both wireless networks, which may in some cases result in multiple copies of a frame being transmitted, which may increase collisions and congestion, thereby decreasing network performance or QoS.

Therefore, according to an example embodiment, an AP may be configured to operate in a multicast-only data transmission mode, in which the AP may transmit only multicast data frames for one or more multicast data streams. In a multicast-only data transmission mode, the AP may transmit multicast data frames (including multicast and/or broadcast data frames), but typically does not transmit unicast data frames. In an example embodiment, when in the multicast-only data transmission mode, the AP may transmit other (non-data) types of frames or traffic, such as control frames/management frames, such as Beacons or Beacon frames. According to an example embodiment, by transmitting, for example, only downlink multicast data traffic in a multicast-only data transmission mode, the AP may better control the amount of transmitted traffic and may deliver the multicast traffic stream(s) and provide a more predictable QoS for a network, regardless of the number of wireless receiver nodes, for example.

Such a multicast-only data transmission mode may be very useful in densely populated areas, or at sporting events or other gatherings where a large number of people or wireless mobile stations are brought together in a relatively small area, or for other applications. If it is desirable to multicast or broadcast audio, video, radio, television, multimedia or other programs or data to a significant number of wireless nodes, configuring an AP in a multicast-only mode may decrease the amount of congestion that may be caused by unicast data transmissions in or around the wireless network, or may offload the transmission of one or more multicast streams or programs to a designated multicast AP, which may serve one or more networks.

In an example embodiment, there may be multiple wireless networks with overlapping coverage, with an AP (or at least one AP) for each wireless network. To avoid duplicate multicast wireless transmissions, one of the APs may be designated or assigned to be a multicast AP for the plurality of wireless networks. Therefore, according to an example embodiment, one (or more) of the APs may be configured in a multicast-only data transmission mode to perform multicast data transmissions for one or more multicast streams for the plurality of wireless networks. Therefore, at least for such multicast streams handled by the designated multicast-only AP, such multicast streams may be transmitted typically by only the multicast-only AP to the plurality of wireless networks, which may avoid or at least decrease multiple copies of multicast frames being transmitted, e.g., since an AP for each network will typically not be multicasting a copy of the multicast stream or program. Thus, in this example embodiment, the designated multicast-only AP may transmit the multicast data stream (e.g., audio, video, multimedia or other program or transmission) across multiple networks. The Multicast-only AP may multicast (e.g., multicast, anycast or broadcast) frames for the data stream onto each of the plurality of networks, or may send a separate copy of the multicast program onto each wireless network (e.g., if different frequencies or channels are used for different wireless networks).

In such an example embodiment, the other APs (non multicast-only APs), may continue to operate normally, e.g., in a unicast-multicast data transmission mode, including transmitting both unicast and multicast data frames, as necessary. In an alternative embodiment, APs that have not been designated as a multicast-only AP may operate, for example, in a unicast-only data transmission mode in which these APs may not typically transmit multicast/broadcast frames (at least for some multicast streams), but have delegated multicast transmissions to such designated multicast AP that may be operating in a multicast-only data transmission mode, although this is optional. This multicast delegation may be performed for one or more multicast streams or programs, or even for all multicast streams or programs for one or more networks.

According to an example embodiment, an AP may notify one or more wireless nodes that that it is operating in a multicast-only data transmission mode. The AP, when operating in a multicast-only data transmission mode, may transmit multicast (including multicast and/or broadcast) data frames. The multicast-only AP may also transmit control or management frames, but typically does not transmit unicast data frames.

According to an example embodiment, the AP may notify other wireless nodes of its operating mode by transmitting a Beacon or a response message (such as a probe response message, an Association Response message or Reassociation Response message) indicating that it is operating in a multi-cast-only data transmission mode. The probe response message may be transmitted in response to a probe request message, and the Association or Reassociation Response message may be transmitted in response to an Association or Reassociation Request message, respectively. In an example embodiment, the Beacon or Probe Response (or other response) message may indicate that the AP is operating in a multicast-only data transmission mode, may identify a type of multicast data transmission or program (e.g., audio or radio transmission, IP television program transmission, a sports program transmission, a video program transmission) that is transmitted by the AP for one or more multicast streams, and may provide an identifier (e.g., multicast group address, a MAC address or other address of an AP or virtual AP, or other identifier) for each of the one or more multicast streams. For example, if a wireless node is interested in receiving a sports program associated with a first multicast group address, the wireless node may become a member of the multicast group or may simply detect frames having the associated multicast group address. Alternatively, the multicast stream delivery setup signaling may be used to provide information of a multicast delivery mechanism.

According to another example embodiment, a wireless communication system that may be used in an AP or other wireless node may include a controller, a memory and a wireless transceiver, for example. For example, the wireless communication system may be configured to operate in a multicast-only data transmission mode. In an example embodiment, the wireless communication system may notify one or more wireless nodes that the system is operating in a multicast-only data transmission mode, and may transmit control (or management) frames and only multicast data frames while operating in the multicast-only data transmission mode (and typically does not transmit unicast data frames). The multicast data frames may include multicast data frames and/or broadcast data frames.

In an example embodiment, an AP operating in a multicast-only data transmission mode may, at least in some cases, transmit multicast frames or multicast streams to one or more wireless node or stations without necessarily associating or authenticating with the wireless nodes, and without necessarily encrypting the transmitted data. Encryption may be handled at a higher layer, such as at an application layer, for example.

In an example embodiment, the multicast AP or AP operating in a multicast-only data transmission node may transmit one or more frames for one or more multicast streams or programs to receiver wireless nodes. The receiver wireless nodes may receive the multicast programs or frames without necessarily associating or authenticating with the AP operating in multicast-only data transmission mode. In an example embodiment, the AP operating in a multicast-only data transmission mode may, for example, not associate or authenticate with any wireless nodes.

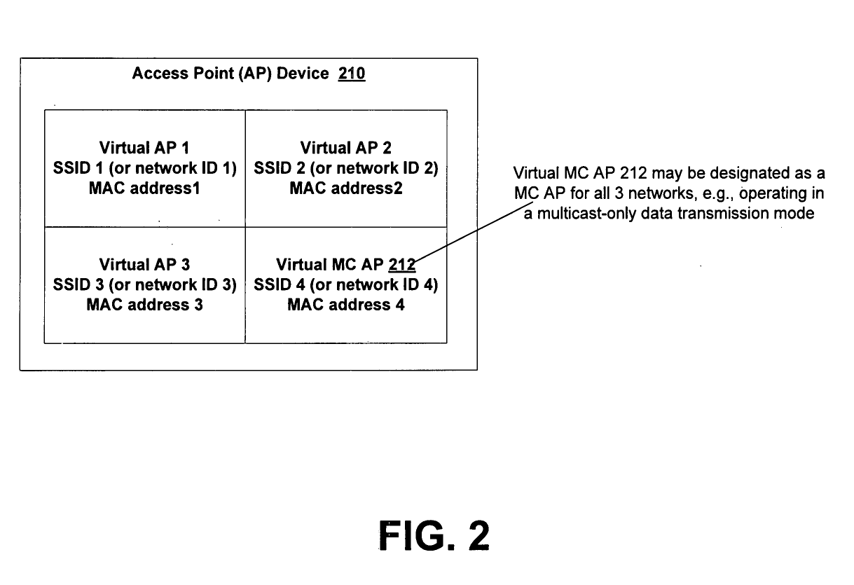

FIG. 2 is a block diagram of an AP device 210 or wireless communications system that may include a plurality of virtual APs. Multiple virtual APs may reside on a single AP device or communication system. Device 210 may include a plurality of virtual APs, including virtual AP 1, virtual AP 2, virtual AP 3 and virtual AP 4. Although four virtual APs are shown, any number of virtual APs may be provided. Each, or one or more, virtual AP may be operating as an access point (AP) or base station for a different wireless network, for example. All of the virtual APs may reside or operate from the single device 210 or communications system. However, other wireless nodes in each of the respective networks may or may not be aware that the virtual AP servicing that network is a virtual AP that may be co-resident with other virtual APs on a device or wireless communication system.

In an example embodiment, all of the virtual APs for device 210 may typically be transmitting or operating on the same frequency or channel (although alternatively, one or more of the virtual APs may transmit or operate on different frequencies).

Virtual AP 1 may use a first MAC (media access control) address, referred to as MAC address 1, and may provide communication services for a first network (virtual AP 1 provided for a first wireless network), which may be identified by SSID 1 (or network ID 1). Likewise, virtual AP 2 may use a second MAC address (MAC address 2), and may be provided for a second wireless network, which may be identified by SSID 2 (or network ID 2). Virtual AP 3 may use a third MAC address (MAC address 3), and may be provided for a third wireless network, which may be identified by SSID 3 (or network ID 3), etc. And, similarly, virtual AP 4 may use a fourth MAC address (MAC address 4), and may be provided for a fourth wireless network, which may be identified by SSID 4 (or network ID 4). Although, for this example, it may be assumed that only three networks are supported, e.g., by virtual AP 1, virtual AP 2 and virtual AP 3.

Although not required, the coverage of the first, second, and third wireless networks (serviced by virtual APs 1-3, respectively) may be the same, may be similar, or may be partially or substantially overlapping with each other, according to an example embodiment. For example, wireless network 1 may be a home network, network 2 may be a hotel network, network 3 may be a public network offered as a service to a local neighborhood or by a broadband service provider, where all three of these networks may overlap substantially in their coverage areas, for example. This is merely an illustrative example embodiment, and any number of wireless networks may be provided and may serve any purpose. Each of these three wireless networks may be serviced by one of the virtual APs, for example, as noted, by virtual AP 1, virtual AP 2, and virtual AP 3, respectively.

In an example embodiment, a multicast program (e.g., a radio program or IP TV program or other data) may be multicasted to each of the wireless networks. In one example embodiment, each of the three virtual APs (virtual AP 1, virtual AP 2 and virtual AP 3) may multicast or transmit the multicast frames onto its respective wireless network. For example, virtual AP 1 may transmit the multicast program to nodes in the first network, virtual AP 2 may transmit the multicast program to nodes in the second wireless network, and virtual AP 3 may transmit the multicast program to nodes in the third wireless network. However, as noted, in an example embodiment, the coverage or scope of each of these three wireless networks may be similar or may at least partially overlap. Therefore, such an approach where each virtual AP transmits a separate copy of the multicast program over its respective network may typically result in three copies of the multicast frames for the program being transmitted, e.g., at the same time, which may create a significant amount of traffic or congestion on the three wireless networks. In an example embodiment, the virtual APs for all three networks may be operating at the same channel or frequency, although this is not required. These networks may alternatively operate on different channels or frequencies.

Therefore, according to an example embodiment, one of the virtual APs, shown as virtual multicast (MC) AP 212 in FIG. 2, may be designated (or operate as) as a virtual multicast (MC) AP for all three wireless networks, e.g., for one or more (or even all) multicast programs or multicast data streams. Thus, for example, in this role as a virtual multicast (MC) AP for all three of the wireless networks, virtual MC AP 212 may, for example, operate in a multicast-only data transmission mode and/or may transmit or handle the multicast data transmission of one or more (or even all) multicast programs or data transmissions for the three networks. Thus, for example, virtual MC AP 212 may transmit one copy of the frame(s) for a particular multicast program or stream (one or more frames) that may be received by nodes on all three wireless networks.

MC AP 212 may alternatively transmit a separate copy of the multicast program onto each of the three networks, e.g., if each network uses a different channel or different encryption or security, etc.

Each of the other virtual APs (virtual AP 1, virtual AP 2 and virtual AP3) may operate in a normal mode or unicast-multicast data transmission mode, in which the virtual AP may transmit both unicast and multicast frames. As noted, the transmission of one or more multicast streams or frames may be delegated (e.g., by virtual AP 1, virtual AP 2 and virtual AP 3) for the three networks to virtual multicast (MC) AP 212. Alternatively, each of these virtual APs (virtual AP 1, virtual AP 2 and virtual AP 3) may operate in a unicast-only data transmission mode, or may at least delegate the transmission of one or more multicast transmission programs or streams to the virtual MC AP 212, for example. For example, although not required, if virtual AP 1, virtual AP 2 and virtual AP 3 operate in a unicast-only mode, all or substantially all of the multicast (including broadcast) transmissions for the three networks may typically be handled by the one or more designated virtual multicast (MC) APs for the networks (virtual MC AP 212 in this example).

Each of the other virtual APs (virtual AP 1, virtual AP 2 and virtual AP3) may collect requests for multicast or other programs or transmissions from wireless nodes in their respective networks, and may pass along these requests to the virtual MC AP.

The virtual MC AP 212, which may be operating in multicast-only data transmission mode, may have an independently named network ID or SSID (e.g., SSID 4), and a separate MAC address (MAC address 4). The SSID used by the virtual multicast AP (e.g., virtual MC AP 212) may characterize or be associated with a program, such as a sports program or musical event, which may be multicast by the virtual multicast AP. There may be one or more virtual multicast (MC) APs, with each multicast AP transmitting one or more multicast programs over one or more wireless networks. Each virtual multicast AP may have a different MAC address and a different SSID or network ID. In another example embodiment, a multicast AP may use a different SSID or network ID or source MAC address for each different multicast program, in order to allow wireless nodes to identify or detect different multicast programs or transmissions, for example. Alternatively, a virtual multicast AP may use a SSID used by one or more of the other virtual APs. In another embodiment, a different multicast (MC) AP may transmit different types of multicast programs or streams. For example, one virtual MC AP may serve or transmit multicast radio news programs, a second MC AP may transmit multicast sports radio programs, a third MC AP for multicast IP TV comedy programs, a fourth MC AP for multicast IP TV sports programs, and a fifth MC AP may transmit a program guide (indicating MAC addresses or multicast group addresses or other identifiers for each multicast program or stream), as examples.

Virtual AP 1, virtual AP 2 and virtual AP 3 may deliver program guides to wireless nodes in their respective networks, e.g., via unicast or multicast or broadcast messages. The program guides may, for example, describe each multicast program or transmission (e.g., sports program, movie, radio channel) and provide an identifier for the multicast program such as a multicast group address, or a MAC address or SSID for the multicast AP that will be transmitting the multicast program, for example. For example, providing the MAC address of the multicast AP that will be transmitting each multicast program or transmission may allow wireless nodes in the networks to receive and detect frames for the multicast transmissions.

In an example embodiment, a wireless communication system (e.g., BS or AP device) may include a plurality of virtual access points (APs). The plurality of APs may include a first virtual AP operating in a multicast-only data transmission mode for a plurality of networks.

In another example embodiment, the wireless communication system may include at least one virtual AP operating in a unicast-only data transmission mode, and at least one virtual AP operating in a multicast-only data transmission mode.

In yet another example embodiment, the communication system may include a plurality of first virtual APs, each first AP serving a different one of a plurality of wireless networks, and at least one virtual AP operating in a multicast-only data transmission mode to transmit multicast data frames for a multicast stream for the plurality of wireless networks.

In another example embodiment, a wireless communication system may include a plurality of virtual access points (APs), at least one of the virtual APs being configured to operate in a multicast-only data transmission mode. In an example embodiment, the virtual AP configured to operate in a multicast-only data transmission mode may be configured to transmit multicast data frames for a multicast stream (or a plurality of multicast streams) over a plurality of wireless networks. The virtual AP operating in multicast-only data transmission mode may be designated to transmit multicast data frames or multicast programs for one or more wireless networks.

According to an example embodiment, each AP or virtual AP may transmit a Beacon including a Traffic Indication Map (TIM). In one embodiment, an AP (or AP device) may transmit one TIM (or TIM Beacon) for all virtual APs operating in the same AP device. For a virtual multicast AP (or MC AP), e.g., operating in a multicast-only data transmission mode, the MC AP may transmit its own DTIM (Delivery Traffic Indication Map), since multicast/broadcast frames may typically be transmitted by an AP after it transmits its DTIM Beacon. In this case, only the virtual MC AP is typically transmitting multicast or broadcast frames, and thus the MC AP may transmit its own DTIM Beacon, for example.

If a virtual MC AP (or other AP operating in a multicast-only data transmission mode) has legacy 802.11 mobile stations (or wireless nodes) in one or more networks serviced by the MC AP, but the legacy stations are not capable of receiving all multicast traffic (e.g., without associating with MC APs), there may be several solutions techniques to address this issue, including: 1) the legacy wireless nodes or stations may associate to the multicast-only AP and receive traffic from it; 2) The multicast-only AP may filter the relevant information for the legacy nodes and transmit this information for the legacy nodes separately (e.g., via unicast transmission). The legacy nodes may require ARP/DNS requests.

A virtual AP operating in a multicast-only data transmission mode (e.g., a virtual MC AP) may typically transmit Beacons to all supported networks with the same DTIM periodicity, since multicast transmissions will typically be transmitted following the DTIM Beacon, in an example embodiment. The DTIM Beacon periodicity (or period) may be kept the same value for all APs or all virtual APs having networks serviced the multicast AP, because this may allow a single multicast transmission for all wireless nodes/all serviced wireless networks. According to an example embodiment, the transmitted DTIM Beacon may have a “DTIM period:” field in the Beacon and “DTIM count” field in the Beacon set to “0” to indicate that the Beacon is transmitted by the virtual MC AP (or the virtual AP operating in a multicast-only data transmission mode). These same parameter values may be used also for an AP operating in multicast-only data transmission mode without virtual AP support (e.g., for a stand-alone AP). In an example embodiment, a virtual AP may be one device that may operate as an AP for multiple networks (e.g., such as multiple virtual APs within one device).

In an example embodiment, the MC AP (e.g., operating in a multicast-only data transmission mode) may transmit only DTIM Beacons (not TIM Beacons), since the MC AP may typically transmit only multicast frames, in an example embodiment. The DTIM Beacon may include a list of multicast and broadcast addresses and the transmission times (or transmission schedule) for each address. The DTIM Beacon may also identify the type of multicast program or stream associated with each multicast group address (or each MAC address). In an example embodiment, specific or known multicast addresses may be used to transmit specific multicast programs, such as sports radio, IP TV movies, IP TV news, a program guide, etc. In another example embodiment, a DTIM Beacon may include or indicate a time period when wireless nodes or mobile stations may request new multicast address delivery by transmitting an IP routing request. IP level multicast routing may use one or more routing protocols.

According to an example embodiment, a virtual MC AP or an AP or virtual AP operating in a multicast-only data transmission mode typically may not allow or respond to authentication or association requests. Thus, in such case, the receiving wireless nodes may filter out or detect desired MAC multicast addresses, such as for multicast programs or data streams that the mobile station would like to receive, even without associating or authenticating to the MC AP.

According to an example embodiment, providing an AP or virtual AP in a multicast-only data transmission mode may decrease congestion or traffic in wireless networks, and may also improve battery life in some cases for wireless nodes, since wireless nodes may remain in a low power or sleep mode if they are not interested in receiving multicast programs. Also, for example, if an AP or virtual AP is transmitting multicast programs or streams or if an AP is operating in a multicast-only data transmission mode, other APs or virtual APs may avoid transmitting frames on the channel used by the MC AP, for example.

An AP (or virtual AP) may initially operate in a normal or unicast-multicast data transmission mode. In an example embodiment, high priority QoS parameters may be applied to multicast data transmissions, e.g., in order to prioritize one or more multicast data transmissions over unicast data transmissions, for example. An example of QoS parameters that may be used in a wireless network may include the EDCA (Enhanced Distributed Channel Access) parameters specified in the IEEE 802.11e specification. Other wireless specifications have proposed a similar set of QoS parameters. For example, a very short delay period after a last transmission may be used, such as a point interframe space (PIFS), or the like, to provide multicast transmissions with relatively high priority, for example. A wide variety of QoS parameters may be employed or adjusted, e.g., to prioritize multicast traffic, such as: a minimum and maximum contention window for the AC (access category), the arbitration inter-frame spacing (AIFS) for the AC, the TXOPLimit[AC] which defines the length of the TXOP (transmission opportunity) that a wireless node is granted, etc.

Also, for example, an AP or virtual AP may protect multicast transmissions by transmitting a CTS (clear to send) to self before transmitting multicast frames or streams.

According to an example embodiment, an AP or virtual AP, initially operating in a normal or unicast-multicast data transmission mode (e.g., BSS or normal mode) may switch to a multicast-only data transmission mode. For example, if a network is lightly loaded, the AP may remain in a unicast-multicast (or normal or BSS) data transmission mode. When traffic level in one or more networks exceeds a threshold, an AP or a virtual AP may switch to a multicast-only data transmission mode, or may be designated by one or more networks to handle multicast transmissions for the network(s). There may be a number of different criteria or parameters that may be measured or detected which may indicate that traffic or congestion in a wireless network(s) has exceeded a threshold, such as indicated by: a measured network usage or used transmission time, e.g., as indicated by a QBSS Load element in 802.11e specification, the QoS of the multicast transmission delivery by the AP, a number or percentage of delivery errors, received error messages, packet retransmissions, network configuration settings from a network management system, etc.

According to an example embodiment, a technique may include an AP operating in a unicast-multicast data transmission mode or a normal BSS mode, detecting that a wireless traffic condition has been met, and switching from the unicast-multicast data transmission mode to a multicast-only data transmission mode. In an example embodiment, the switching may include disassociating from any wireless node that an AP or virtual AP may currently be associated with, discontinuing any further unicast data transmissions, and transmitting only multicast data transmissions (e.g., in a multicast-only data transmission mode). In another example embodiment, the switching may include, for example, operating, for a period of time, in a parallel operation of a unicast/multicast data transmission mode and a multicast-only data transmission mode, disassociating from any currently associated wireless nodes (e.g., an AP or virtual AP disassociating from any currently associated nodes), and discontinuing operation of the unicast-multicast data transmission mode while continuing operation of the multicast-only data transmission mode.

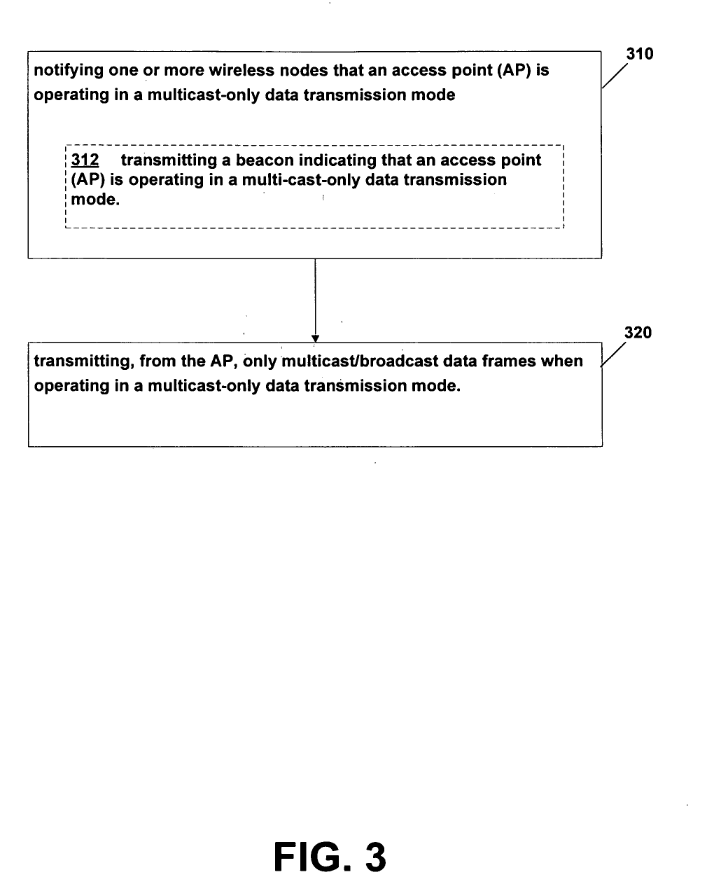

FIG. 3 is a flow chart illustrating operation of a system according to an example embodiment. At 310, one or more wireless nodes may be notified that an access point (AP) (such as an AP or virtual AP) is operating in a multicast-only data transmission mode.

According to an example embodiment, the notifying operation (310) may include transmitting a Beacon indicating that an access point (AP) is operating in a multi-cast-only data transmission mode (312). The transmitting the Beacon (312) may include, for example, transmitting, from an access point (AP), a Beacon or probe response (or other response) that indicates that the AP is operating in a multicast-only data transmission mode, the Beacon also identifying a type of multicast data traffic (e.g., audio or radio transmission, IP television program transmission, a sports program transmission, a video program transmission) that is transmitted by the AP for one or more multicast streams, and providing an identifier (e.g., multicast group address, a MAC address or other address of an AP or virtual AP, or other identifier) for each of the one or more multicast streams.

At 320, the AP may, according to an example embodiment, transmit only multicast/broadcast data frames when operating in a multicast-only data transmission mode. Control frames or management frames (such as a Beacon or Beacon frames, etc.) may also be transmitted while in a multicast-only data transmission mode. For example, unicast data frames are typically not transmitted by an AP when the AP is in multicast-only data transmission mode.

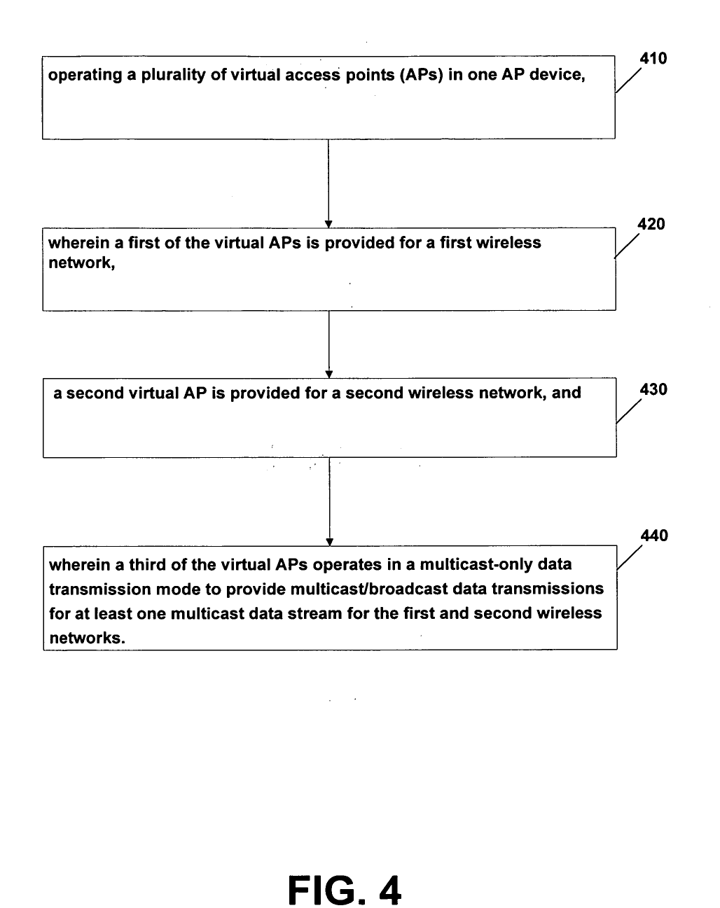

FIG. 4 is a flow chart illustrating operation of a system according to another example embodiment. At 410, a plurality of virtual access points (APs) may be operating in a single AP device. At 420, a first of the virtual APs may be provided (e.g., to service) for a first wireless network. At 430, a second of the virtual APs may be provided for a second wireless network. At 440, a third of the virtual APs may operate in a multicast-only data transmission mode to provide multicast/broadcast data transmissions for at least one multicast data stream for the first and second wireless networks.

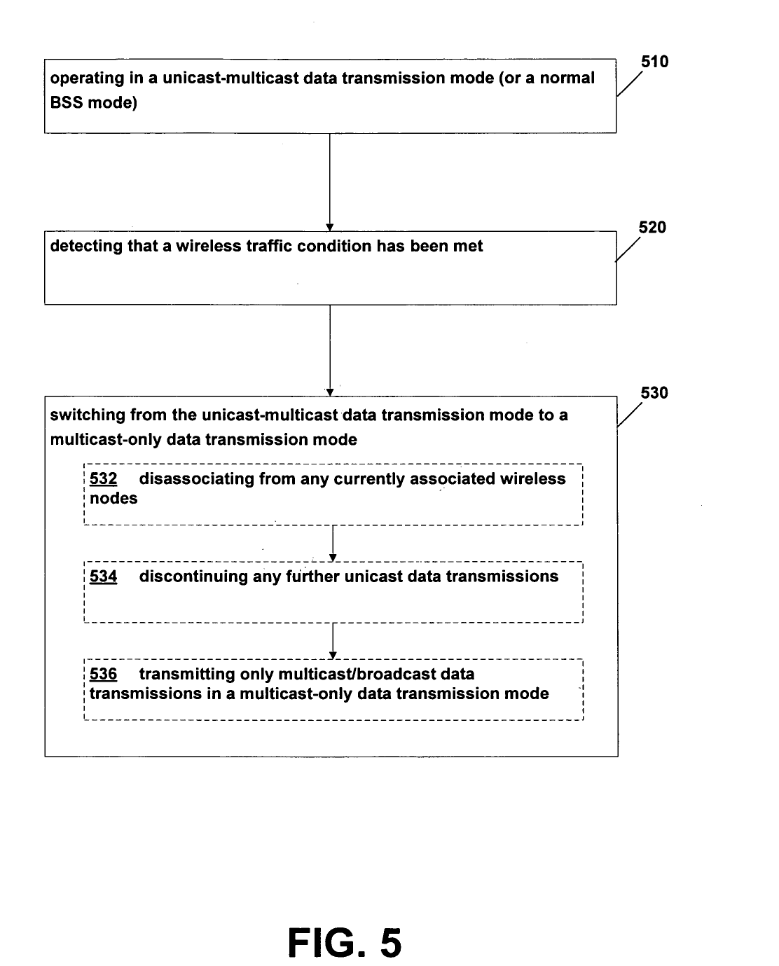

FIG. 5 is a flow chart illustrating operation of a system according to yet another example embodiment. At 510, an AP (e.g., AP or virtual AP) may operate in a normal or BSS mode (e.g., unicast-multicast data transmission mode). At 520, it is detected that a wireless traffic condition has been met, e.g., traffic or congestion in one or more wireless networks has exceeded a threshold.

At 530, the AP (e.g., AP or virtual AP) may switch from the normal or BSS mode (e.g., unicast-multicast data transmission mode) to a multicast-only data transmission mode. Operation 530 may include, for example, disassociating from any currently associated wireless nodes (532), discontinuing any further unicast data transmissions (534), and transmitting only multicast/broadcast data transmissions in a multicast-only data transmission mode (536).

In another example embodiment, an AP may operate in a broadcast-only data transmission mode in which the AP may typically transmit only broadcast data frames, with the principles described above for multicast-only data transmission mode may also be applied similarly to such a broadcast-only data transmission mode.

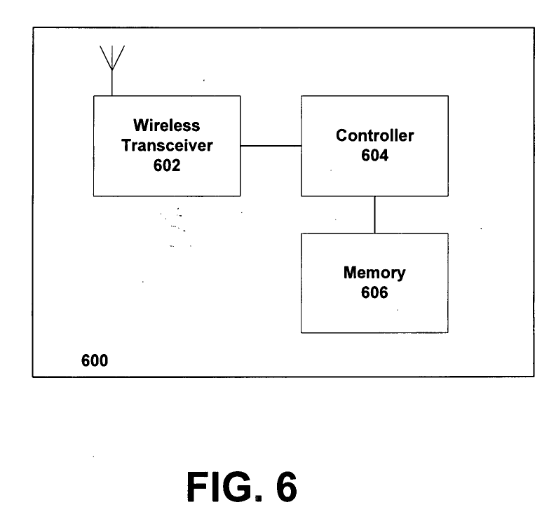

FIG. 6 is a block diagram illustrating an apparatus 600 that may be provided for wireless communications, e.g., in a wireless node according to an example embodiment. The wireless node (e.g. station, BS or AP) may include, for example, a wireless transceiver 602 to transmit and receive signals, a controller 604 to control operation of the station and execute instructions or software, and a memory 606 to store data and/or instructions. Controller 604 may be programmable and capable of executing software or other instructions stored in memory or on other computer media to perform the various tasks and functions described herein.

In an example embodiment, an AP that may be operating in a multicast-only data transmission mode may receive requests from any wireless node to receive a specific multicast or broadcast stream. Therefore, in one example embodiment, the multicast-only AP may receive requests directly from wireless nodes to receive streams for one or more broadcast/multicast streams. In another example embodiment, requests to receive a multicast/broadcast stream may be transmitted via a unicast-only AP (e.g., operating in a unicast-only data transmission mode) to the multicast-only AP. For example, if an AP operating in a multicast-only data transmission mode (e.g., multicast-only AP) is serving or providing multicast services to one or more other APs (e.g., unicast-only APs or APs operating in a unicast-only data transmission mode), the associated wireless nodes may submit a request to receive one or more multicast/broadcast streams to the associated unicast-only AP. The unicast-only AP may then forward the request for the multicast or broadcast stream, which then may grant or accommodate the request by transmitting the request multicast/broadcast stream, e.g., at the time requested by the requesting wireless node.

A number of additional example embodiments and further example details will now be described. The various embodiments described below may apply to both access points (APs) as well as virtual APs. For example, one AP (which may be operating in a unicast-only data transmission mode) may rely on another AP to provide multicast/broadcast services for a network. Likewise, one virtual AP (e.g., operating in a unicast-only data transmission mode) may rely on another virtual AP for multicast/broadcast services. The examples and descriptions provided herein (e.g., FIGS. 1-9) are described with respect to APs, but apply equally to virtual APs.

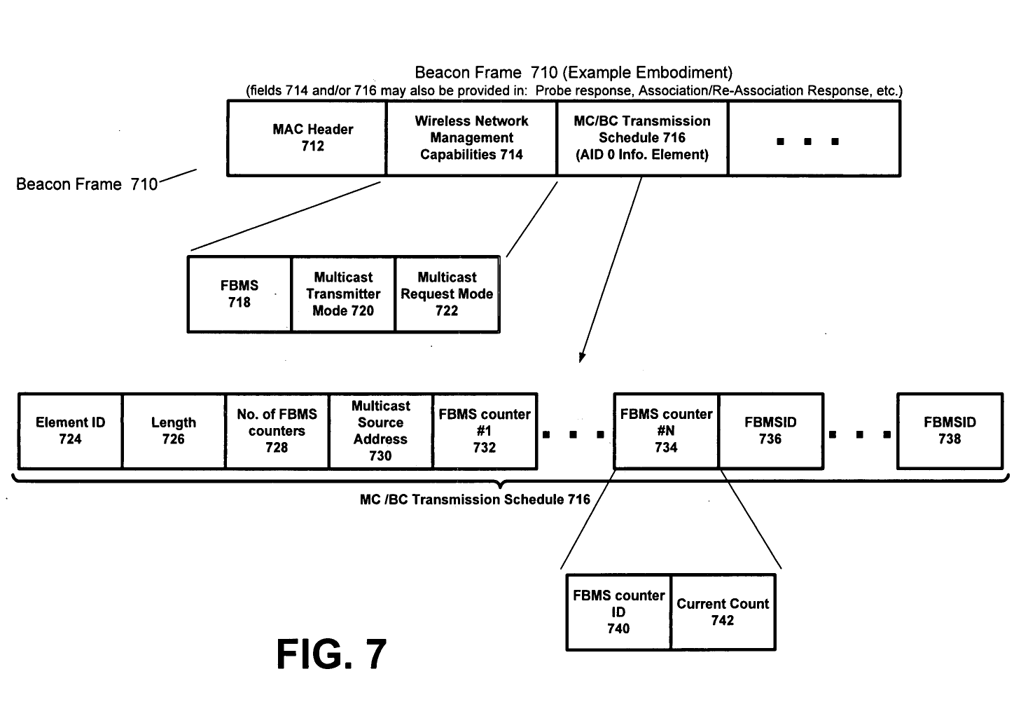

FIG. 7 is a block diagram illustrating a Beacon (or Beacon frame) according to an example embodiment. Beacon frame 710 may be transmitted or broadcast by an access point AP), mesh point (MP) or other wireless node. Beacon frame 710 may include a MAC header 712, and other fields not shown.

The Beacon frame 710 may provide information that may describe the transmitting AP, such as the capabilities, features, modes of operation, etc., relating to the transmitting AP. The Beacon frame 710 may include a wireless network management capabilities field 714 and a multicast/broadcast transmission schedule 716. Other fields may be included within Beacon 710, which are not shown in FIG. 7. One or both of fields 714 and 716 may alternatively be provided or transmitted by an AP (or other node) within a probe response (e.g., in response to a probe request from a wireless node), an association response (e.g., in response to an association request), a Reassociation Response (e.g., in response to a Reassociation Request), or other message or frame.

Wireless network management capabilities field 714 may include a FBMS field 718 that may indicate whether or not the AP supports a flexible broadcast/multicast service (FBMS). FBMS may be a service that may allow a wireless node to request an interval for wireless delivery or transmission or multicast/broadcast frames that is longer than a normal DTIM interval. Thus, with FBMS, a wireless node may request an AP to deliver frames for a multicast/broadcast stream every N DTIM intervals, where N may be 1, 2, 3, etc. By permitting spacing of multicast/broadcast frame delivery from an AP to the wireless node(s) at longer intervals (e.g., multiple DTIM intervals rather every DTIM), this may allow a wireless node (or station) to remain in a low power state for a longer period of time, which may improve battery life for the wireless node in some cases. For example, if FBMS field 718 is set to 1, then this may indicate to wireless nodes that the AP may allow delivery of frames for multicast/broadcast streams at flexible or variable DTIM intervals, e.g., at one or more DTIM intervals, as agreed or negotiated between the wireless node and AP.

Field 714 may also include a multicast transmitter mode field 720 and a multicast request mode field 722. In an example embodiment, fields 720 and 722 may be present if FBMS field 718 is set to a value (e.g., 1) indicating that the AP supports FBMS. According to an example embodiment, fields 720 and 722 may each be set to one of four different values (e.g., 00, 01, 10 and 11), as an example. Each of the four modes or values will be briefly described for both fields 720 and 722, described below as cases 1)-4) for each of fields 720 and 722. The four modes for fields 720 and 722 described below are merely examples, and other modes or variations of the described modes may be provided.

In an example embodiment, when the FBMS field 718 is set to a value (e.g., 1) indicating that the AP supports FBMS, the multicast transmitter mode field 720 may identify a data transmission mode for the AP for multicast/broadcast transmissions. In an example embodiment, multicast transmitter mode field 720: 1) may be set to 00 to indicate that the AP is operating in a unicast-multicast data transmission mode (e.g., normal BSS mode) in which both unicast and multicast data frames are transmitted by the AP.

Also, multicast transmitter mode field 720 2) may be set to 01 to indicate that the multicast/broadcast frames for one or more identified streams are transmitted by a multicast AP according to the MC/BC transmission schedule 716. As described in greater detail below, the MC/BC transmission schedule 716 (or AID 0 IE) may provide information relating to one or more multicast/broadcast streams for which frames have been buffered for transmission or scheduled for transmission. The MC/BC transmission schedule 716 may, for example, identify a multicast source address or MAC address of a multicast AP that is transmitting the multicast/broadcast stream(s), and may provide identifiers for each the transmitted multicast/broadcast streams and timing information indicating when the frames for the multicast/broadcast streams are scheduled for transmission.

Also, the multicast transmitter mode field 720: 3) may be set to 10 to indicate that all (or substantially all) multicast/broadcast streams are transmitted by an AP identified in the MC/BC transmission schedule. Thus, in this mode (10), this AP (having a multicast transmitter field 720 set to 10) may typically be operating in a unicast-only data transmission mode, and, e.g., may be relying on the identified multicast-only AP (e.g., identified by MC/BC transmission schedule 716) to transmit multicast/broadcast streams to its associated wireless nodes. In addition, multicast transmitter mode field 720: 4) may be set to 11 to indicate that this AP is operating in a multicast-only data transmission mode. In such a case, where multicast transmitter mode field is set to 11, this may indicate that this AP is providing multicast/broadcast services for one or more other APs (e.g., one or more APs that may be operating in a unicast-only data transmission mode).

Also, in an example embodiment, the multicast request mode field 722 may (e.g., if FBMS filed 718 is set to 1) identify a request mode for the AP, which may indicate a recommended or even required mode or technique through which wireless nodes may request transmission or delivery of a multicast/broadcast stream. The multicast request mode field 722: 1) may be set to 00 to indicate that FBMS requests may be transmitted (e.g., directly) to the multicast source address (or multicast AP) identified by the MC/BC transmission schedule 716 (e.g., identified by multicast source address field 730);

Also, the multicast request mode field 722: 2) may be set to 01 to indicate that FBMS requests should be transmitted to the MAC address of this AP. In such a case, this receiving AP (receiving the FBMS request) may, therefore, receive the FBMS requests from wireless nodes in a network and may transmit the requested multicast/broadcast streams to the requesting nodes (e.g., if the receiving AP is operating in a normal or unicast-multicast data transmission mode), or may forward the FBMS request to an AP that is providing multicast-broadcast services for the AP (e.g., if this receiving AP is operating in a unicast-only data transmission mode and relying on another AP operating in a multicast-only data transmission mode to provide multicast/broadcast services).

In addition, the multicast request mode field 722: 3) may be set to 10 to indicate that FBMS requests shall be sent only to the multicast source address (or multicast AP) identified (e.g., by field 730) by the MC/BC transmission schedule 716 (or AID 0 information element). The multicast request mode field 722 4) may be set to 11 to indicate that FBMS requests should not be transmitted from wireless nodes, e.g., from the wireless nodes associated with this AP.

Beacon frame 710 may also include a multicast/broadcast (MC/BC) transmission schedule field 716 describing one or more multicast/broadcast transmissions. In an example embodiment, the MC/BC transmission schedule field 716 (which may also be referred to as an Association Identifier bit 0 information element) may be present in an AP's Beacon (or other message) if FBMS field 718 is set to a value (e.g., 1) indicating support for FBMS.

MC/BC transmission schedule field 716 may include a number of fields, which will be briefly described. An element ID 724 may identify that field 716 (or information element 716) is a MC/BC transmission schedule field. Length field 726 may identify the length (e.g., in bytes) of the field 716. A multicast source address field 730 may identify the MAC address (or other address) of the AP that is transmitting multicast/broadcast data transmissions for one or more identified streams. The multicast source address field 730 may identify the MAC address of the transmitting AP, e.g., if the AP is transmitting its own multicast/broadcast frames or operating in a normal or unicast-multicast mode, for example. On the other hand, in an example where the transmitting AP may be operating in a unicast-only data transmission mode (or otherwise relying on another AP for multicast/broadcast services), the multicast source address field 730 may identify a MAC address of the other AP that is providing the multicast/broadcast services for the AP, such as an AP operating in a multicast-only data transmission mode. As noted above, the various example embodiments herein may apply to both APs and virtual APs. Thus, the multicast source address field 730 may provide a MAC address (or other address) of an AP or a virtual AP that is providing multicast/broadcast services.

A FBMS identifier (FBMSID) may be provided to identify each multicast/broadcast stream that is scheduled for transmission from the multicast source address identified by multicast source address field 730. For example, FBMSIDs may include FBMSID 736 and FBMSID 738, etc. A field 728 may identify a number of FBMS counters. There may also be provided one or more FBMS counters, such as FBMS counter #1 (732), FBMS counter #2, . . . FBMS counter #N (734). Each FBMS counter may identify the DTIM Beacon after which broadcast or multicast frames assigned to a particular delivery interval will typically be transmitted. A FBMS counter is associated with each FBMSID, which may have the effect of identifying a next transmission time for frames of each scheduled multicast/broadcast stream. There may be one or more FBMSIDs associated with each counter.

In an example embodiment, each FBMS counter (such as FBMS counter #N, 734) may include a FBMS counter ID to identify the FBMS counter, and a current count field 742 to indicate how many DTIM Beacons (including the current one) appears before the next DTIM after which the multicast/broadcast frames (for the associated FBMSID) will be transmitted.

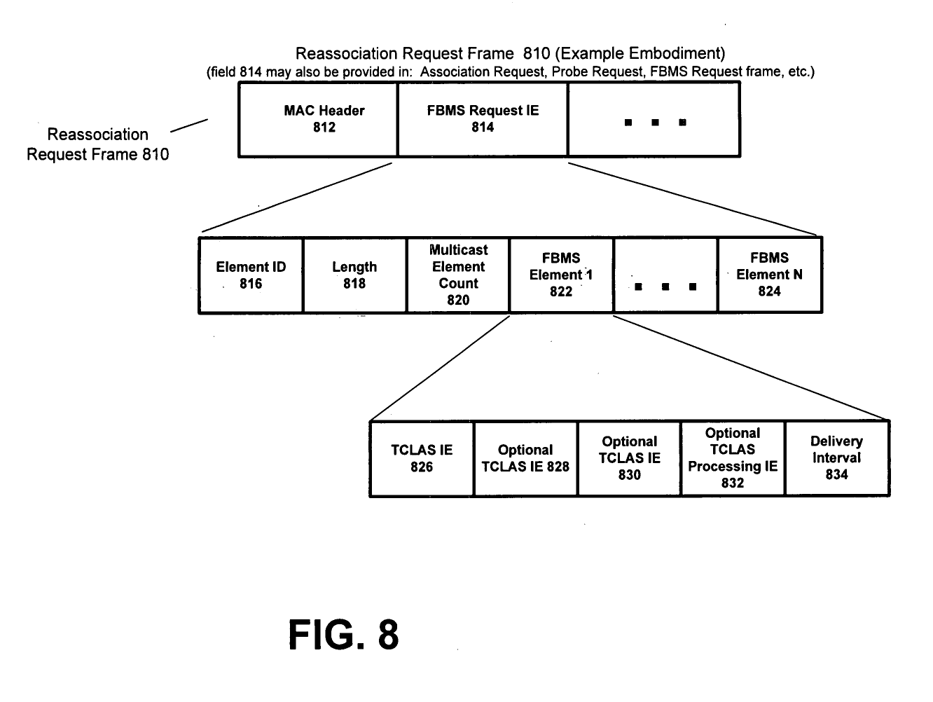

FIG. 8 is a diagram illustrating a Reassociation Request frame 810 according to an example embodiment. The Reassociation Request frame 810 may include a MAC header 812 and other fields not shown. Reassociation Request frame 810 may also include a FBMS request information element (FBMS request IE) 814 to provide information about (or relating to) multicast/broadcast frames or streams being requested by the wireless node. The FBMS request IE 814 may also be provided within an association request, Reassociation Request, a FBMS request or other message. Thus, a wireless node may send a request for delivery of one or more multicast/broadcast streams (using the FBMS request IE 814) within an association request, a Reassociation request, or an FBMS request frame (which may be a separate message that may be send the FBMS request to an AP).

According to an example embodiment, the FBMS request IE 814 may include a number of fields, such as an element ID field 816 identifying the IE as a FBMS request IE, a length field 818, e.g., identifying a length of the FBMS request IE, a multicast element count field 820 identifying the number of FBMS elements present in IE 814, and one or more FBMS elements, such as FBMS element 1 (822), FBMS element 2, . . . FBMS element N (824).

Each FBMS element (such as FBMS element 1, 822) may include a number of fields that may describe the multicast/broadcast stream, such as a TCLAS (traffic classification) IEs 826, 828 and 830 to classify the stream, a TCLAS processing IE 832 to identify how to handle or process multiple TCLAS IEs, and a delivery interval 834 that may define the number of DTIMs that the frames for the stream may be transmitted. In an example embodiment, the FBMS element 822 may allow a wireless node to request a traffic classification (such as a user priority) and a delivery interval for a multicast/broadcast stream.

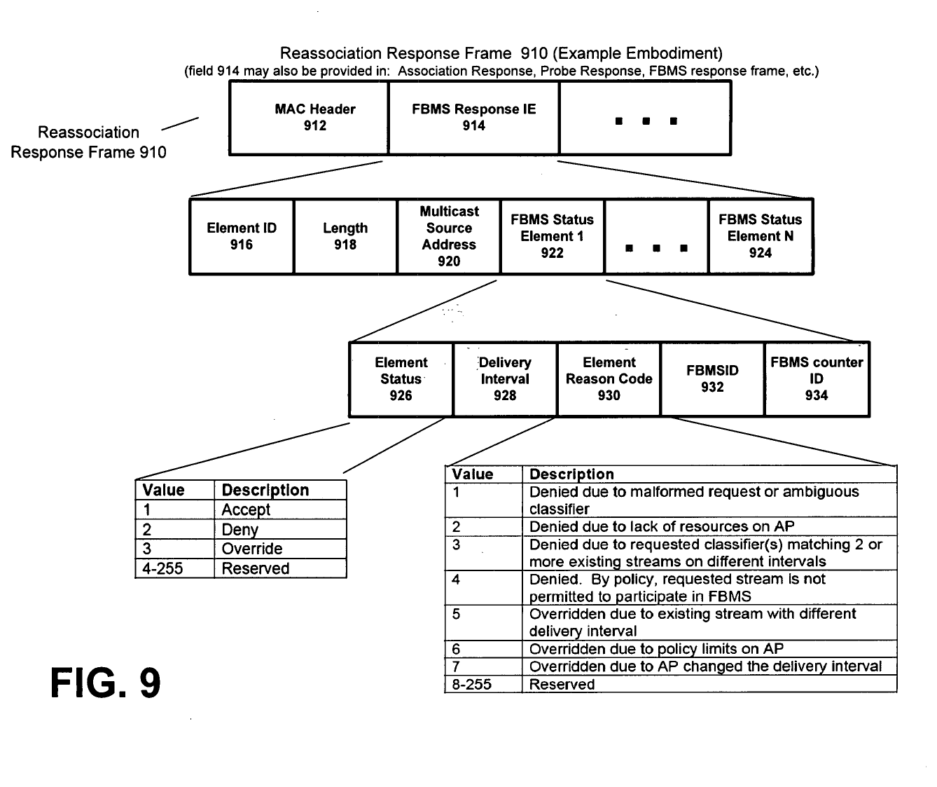

In response to receiving a Reassociation Request 810, the AP may then send a Reassociation Response. FIG. 9 is a diagram illustrating a Reassociation response frame 910 according to an example embodiment. The Reassociation Response frame 910 may include a MAC header 912, a FBMS response information element (FBMS response IE) 914, and other fields (not shown). The FBMS response IE 914 may alternatively be transmitted by an AP or wireless node within an association response, a probe response, a FBMS response, or other message or frame.

The FBMS response IE 914 may include a number of fields, such as an element ID 916 identifying IE 914 as an FBMS response IE, a length field 918 identifying a length of the IE 914 or frame 910, a multicast source address 920 to identify the MAC address or other address (e.g., of the AP or virtual AP) that is transmitting the multicast/broadcast frames for the FBMSIDs identified in the FBMS response IE 914.

FBMS response IE 914 may also include one or more FBMS status elements, such as FBMS status element 1 (922), . . . FBMS status element N (924). Each FBMS status element may describe or provide information relating to the status of the multicast/broadcast stream identified by the FBMSID. For example, each FBMS status element may include an FBMSID 932 identifying the multicast/broadcast stream, a delivery interval 928, which may be the same or different than the requested delivery interval (834) included in the FBMS request IE, and a FBMS counter ID 934 to identify the FBMS counter that will be used to identify a DTIM or time of delivery or transmission for a next frame(s) for the stream.

The FBMS status element 922 may also include an element status field 926 to identify the status of the FBMS request for the FBMSID. The element status (for the FBMSID) may indicate a status of: 1) accept—which may indicate that the AP has accepted the requested delivery interval), 2) deny—which may indicate that the AP has completely denied the requested delivery interval and requested TCLAS), 3) override—which may indicate that the AP denies the requested delivery interval but can support an alternate delivery interval for the requested TCLAS. In an example embodiment, the requesting wireless node should typically comply with the AP's override value (e.g., alternative TCLAS that will be supported by the AP), or otherwise send a new FBMS request to the AP with the TCLAS removed. An element reason code 930 may provide a reason or further details relating to the element status field 926. The element reason code 930 may indicate a code of: 1) denied—due to malformed request or ambiguous classifier, 2) denied due to lack of resources on AP, 3) denied—due to requested classifier(s) matching an existing stream on a different interval, 4) denied—by policy—stream is not permitted to participate in FBMS, 5) overridden—due to existing stream with different delivery interval, 6) overridden due to policy limits on AP, and 7) overridden due to AP changing the delivery interval.

In an example embodiment, a wireless node or that wishes to use the FBMS may send a FBMS request or Reassociation Request with all FBMS elements for which it wants to subscribe (or receive data frames). This may be a declaration of all streams in which the wireless node is interested. For each stream, the wireless node may propose a delivery interval for the requested FBMS element. The AP may adopt the proposed delivery interval or provide an alternate delivery interval for the stream. The FBMS delivery interval may be an integer multiple of the DTIM Beacon period. If the AP denies the usage of FBMS for a particular traffic stream, normal broadcast and multicast transmission rules may typically apply.

An AP may support up to eight (as an example) different delivery intervals. Corresponding to these eight delivery intervals are eight FBMS counters. Each counter decrements once per DTIM Beacon and when the counter reaches zero, the delivery interval expires. Upon expiry, the AP schedules for transmission any frames present for broadcast or multicast streams assigned to that interval. According to an example embodiment, upon request from the wireless node, an AP assigns broadcast and multicast streams to a particular ID (the FBMSID), negotiates the delivery Interval and assigns a counter (the FBMS Counter ID) using the FBMS Element.

An AP may use the MC/BC transmission schedule field 716 (which may also be referred to herein as the AID 0 Information element) in Beacon frames to indicate to which broadcast or multicast addresses the buffered broadcast/multicast frames are targeted. In one example embodiment, this field may be present typically only if the bit for AID 0 (e.g., indicating buffered MC/BC frames at the AP) is set to 1.

A wireless node or station may indicate that it is not using a particular FBMS Element anymore by transmitting a FBMS request frame without that FBMS Element contained in it. The AP may then, for example, send a FBMS response with FBMS status value (or Element status) set to Accept, upon receipt of the FBMS Request.

If an AP receives an FBMS request for an FBMS stream which has already been assigned to a particular delivery interval (and FBMS counter ID), the AP may adjust the corresponding FBMS current count so as to align the transmission time of the requested stream to the transmission time of other FBMS streams for which the requesting wireless node is already receiving. The AP may accomplish this by changing the current count of the requested FBMS stream. The current count may be changed, for example, by holding the value of the current count the same in two consecutive Beacons in which the current count field appears.

An AP may update the delivery interval for a FBMSID by sending an unsolicited FBMS response to the appropriate address with updated delivery interval when the current count for the FBMS stream reaches zero.

The delivery interval for a FBMS stream is created by using the FBMS Request and Response frames or by using Reassociation Request and Response frames. A non-AP STA wishing to use FBMS can propose an delivery interval to the AP for FBMS streams. FBMS Delivery Interval can be multiple of DTIM periods. The AP shall make the selection of the FBMS delivery interval and shall indicate it by using the FBMS Response or Reassociation Response frame.

In an example embodiment, an APs may send a MC/BC transmission schedule 716 (AID 0 IE) in each Beacon frame containing the bit for AID 0 set to 1 if there is one or more FBMS set up for delivery. The MC/BC transmission schedule 716 may contain information about to which broadcast and/or multicast groups the buffered frames in the AP belong to.

If FBMS is used by an AP, the AP may typically include a MC/BC transmission schedule 716 in every Beacon where the bit for AID 0 is set to 1 (e.g., indicating buffered multicast/broadcast frames at the AP for transmission). The MC/BC transmission schedule 716 (or AID 0 IE) may indicate all the broadcast and/or multicast groups or streams for which the AP is having buffered frames.

According to an example embodiment, if FBMS is used, an AP may typically send all broadcast or multicast frames belonging to particular FBMS element immediately after the DTIM having current count of FBMS counter field set to 0 for that particular FBMS stream. If any of the associated wireless nodes are using FBMS then the EOSP field of each multicast or broadcast frame may be set to indicate the presence of further buffered multicast frames belonging to the multicast or broadcast address of that particular frame. The More Data field of each multicast or broadcast frame may be set to indicate the presence of further buffered broadcast/multicast frames. If the AP is unable to transmit all the buffered broadcast or multicast frames before the next TBTT (target Beacon transmission time), the AP may indicate that it will continue to deliver the multicast/broadcast frames by setting the bit for AID 0 in TIM field to 1 and by setting the MC/BC transmission schedule 716 (or AID 0 IE) to indicate to which group addresses or streams there are still buffered frames. In an example embodiment, the MC/BC transmission schedule 716 may be present in the AP's Beacon until all buffered broadcast and multicast frames have been transmitted by the AP.

According to an example embodiment, if the wireless node (e.g., non-AP) is using FBMS, it shall wake up before the DTIM having current count (e.g., 742) of FBMS counter field (e.g., 734) set to 0 for that particular FBMS stream. The wireless node may, for example, remain awake until the More Data field of the multicast or broadcast frame(s) indicates there are no further buffered broadcast/multicast frames or until the EOSP bits indicates no further buffered frames belonging to all broadcast and multicast addresses of which the wireless node is using or bit for AID 0 in TIM filed is set to 0, or until MC/BC transmission schedule 716 indicates that there are no further buffered multicast frames belonging to broadcast and multicast groups (or multicast/broadcast streams) of which the wireless node is using or requested delivery. These are merely some examples of operation, and many other embodiments may be provided.

In addition, a storage medium may be provided that includes stored instructions, when executed by a controller or processor that may result in the controller 604, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
notifying one or more wireless nodes that an access point (AP) is operating in a multicast-only data transmission mode;
transmitting, from the AP, only multicast or broadcast data frames when operating in a multicast-only data transmission mode.

2. The method of claim 1 wherein the notifying comprises transmitting a Beacon or response indicating that an access point (AP) is operating in a multi-cast-only data transmission mode.

3. The method of claim 2 wherein the transmitting a Beacon or response comprises transmitting, from an access point (AP), a Beacon or response, the Beacon or response indicating that the AP is operating in a multicast-only data transmission mode, the Beacon or response also identifying a type of multicast data traffic that is transmitted by the AP for one or more multicast streams, and providing an identifier for each of the one or more multicast streams.

4. The method of claim 3 wherein the Beacon or response identifying a type of multicast data traffic that is transmitted by the AP for one or more multicast streams comprises the Beacon or response identifying that the AP identifies one or more types of multicast data traffic including identifying one or more of:
a video transmission;
audio or radio transmission;
a television program transmission;
a transmission of a television program of a specific type; or
a multimedia program.

5. The method of claim 3 wherein the Beacon or response providing an identifier for each of the one or more multicast streams comprises the Beacon or response providing an identifier for each of the one or more multicast streams, the identifier for each of the one or more streams comprising one or more of: an address of the AP, a MAC address of the AP, an IP address of the AP, or a multicast group address.

6. The method of claim 1 wherein the transmitting comprises transmitting, from the AP, control frames including a Beacon or other response message, and only multicast or broadcast data frames to each of a plurality of wireless networks when operating in a multicast-only data transmission mode.

7. An apparatus for wireless communications, the apparatus comprising a controller, the apparatus configured to operate in a multicast-only data transmission mode.

8. The apparatus of claim 7 and further comprising:
a memory coupled to the controller; and
a wireless transceiver.

9. The apparatus of claim 7 wherein the apparatus being configured to operate in a multicast-only data transmission mode comprises the apparatus being configured to:
notify one or more wireless nodes that the apparatus is operating in a multicast-only data transmission mode;
transmit control frames and only multicast or broadcast data frames while operating in the multicast-only data transmission mode.

10. The apparatus of claim 9 wherein the apparatus being configured to notify comprises the apparatus being configured to transmit a Beacon or response indicating that the apparatus is operating in a multi-cast-only data transmission mode.

11. The apparatus of claim 9 wherein the apparatus being configured to notify comprises the apparatus being configured to transmit a data transmission schedule for a multicast data transmission stream.

12. The apparatus of claim 7 wherein the apparatus comprises a plurality of virtual access points (APs), the plurality of APs including a first virtual AP operating in a multicast-only data transmission mode for a plurality of networks.

13. The apparatus of claim 7 wherein the apparatus comprises:
at least one virtual AP operating in a unicast-only data transmission mode;
at least one virtual AP operating in a multicast-only data transmission mode.

14. The apparatus of claim 7 wherein the apparatus comprises:
a plurality of first virtual APs, each first AP serving a different one of a plurality of wireless networks;
at least one virtual AP operating in a multicast-only data transmission mode to transmit multicast data frames for a multicast stream or a broadcast stream for the plurality of wireless networks.

15. A method comprising:
operating a plurality of virtual access points (APs) in one AP device, wherein a first of the virtual APs is provided for a first wireless network, a second virtual AP is provided for a second wireless network, and wherein a third of the virtual APs operates in a multicast-only data transmission mode to provide multicast or broadcast data transmissions for at least one multicast or broadcast data stream for the first and second wireless networks.

16. An apparatus for wireless communications, the apparatus comprising a plurality of virtual access points (APs), at least one of the virtual APs configured to operate in a multicast-only data transmission mode.

17. The apparatus of claim 16 wherein the virtual AP configured to operate in a multicast-only data transmission mode comprises a virtual AP configured to transmit multicast or broadcast data frames for a multicast or broadcast stream over a plurality of wireless networks.

18. A method comprising:
operating in unicast-multicast data transmission mode or a normal BSS mode; and
switching from the unicast-multicast data transmission mode to a multicast-only data transmission mode.

19. The method of claim 18 wherein the switching comprises:
detecting that a wireless traffic condition has been met; and
switching from the unicast-multicast data transmission mode to a multicast-only data transmission mode based on the detecting.

20. The method of claim 18 wherein the switching comprises:
disassociating from any currently associated wireless nodes;
discontinuing any further unicast data transmissions; and
transmitting only multicast data transmissions in a multicast-only data transmission mode.

21. The method of claim 18 wherein the switching comprises:
operating, for a period of time, in a parallel operation of a unicast/multicast data transmission mode and a multicast-only data transmission mode;
disassociating from any currently associated wireless nodes; and
discontinuing operation of the unicast-multicast data transmission mode while continuing operation of the multicast-only data transmission mode.

22. An apparatus for wireless communications, the apparatus comprising:
a controller,
a memory coupled to the controller; and
a wireless transceiver, the apparatus configured to:
operate in unicast-multicast data transmission mode or a normal BSS mode;
detect that a wireless traffic condition has been met; and
switch from the unicast-multicast data transmission mode to a multicast-only data transmission mode.

23. An article comprising:
a storage medium;
said storage medium including stored thereon instructions that, when executed by a processor, result in:
notifying one or more wireless nodes that an access point (AP) is operating in a multicast-only data transmission mode;
transmitting, in the multicast-only data transmission mode, control frames and only multicast or broadcast data frames.
